(19) United States
(12) Patent Application Publication
(10) Pub. No.: US 2025/0210887 A1
(43) Pub. Date: Jun. 26, 2025

(54) PROTECTIVE STRUCTURE FOR WIRING TERMINAL OF GFCI SOCKET

(71) Applicant: Zhejiang Yuchuang Electronic Technology Co., Ltd, Wenzhou City (CN)

(72) Inventors: Yangen Chen, Wenzhou City (CN); Jingzheng Chen, Wenzhou City (CN)

(21) Appl. No.: 18/393,744

(22) Filed: Dec. 22, 2023

(51) Int. Cl. H01R 4/70; H01R 13/506; H01R 13/713

(52) U.S. Cl. CPC H01R 4/70; H01R 13/506; H01R 13/7135

(57) ABSTRACT

The present invention relates to a protective structure for a wiring terminal of a ground fault circuit interrupter (GFCI) socket. The protective structure includes a housing, where an electronic assembly is arranged in the housing, the wiring terminal is arranged on an outer side of the housing, a protective cover is arranged at the wiring terminal, the protective cover is detachably connected to the housing in a buckled manner, and the protective cover covers an exposed portion of an electric conductor of the wiring terminal. The protective cover of the socket can be inserted and buckled on the housing of the socket after the wiring terminal is connected to a conductive wire, two covering sheets achieve insulation protection by covering the wiring terminal, and the wiring terminal is prevented from being touched by mistake to influence conductive connection. Furthermore, the protective cover of the present invention employs an insertion structure between an inserting block and a slot to achieve a fixing structure of three-point positioning in combination with clamped connection between clamping grooves formed by L-shaped clamping members and side portions of the covering sheets, assembly and disassembly are both quite convenient, and only downward insertion and pressing on both sides as well as simultaneous upward pushing are needed.

### TECHNICAL FIELD

The present invention relates to the technical field of leakage protectors, and in particular to a protective structure for a wiring terminal of a ground fault circuit interrupter (GFCI) socket.

### BACKGROUND

A ground fault circuit interrupter (GFCI) is a ground fault leakage protector, which is a device intended to protect people from a severe or fatal electric shock. Since the GFCI detects a ground fault, the GFCI can also prevent some electrical fires and interrupt currents harming people seriously. The working principle is as follows: in a household wiring system, on one power socket, a current of a live wire and a current of a neutral wire should be equal in a normal case. The GFCI monitors a current difference between the live wire and the neutral wire, and once the difference is greater than 4-6 milliamperes, the GFCI can cut off a power supply to prevent fatal power, thereby ensuring personal safety. For example, a GFCI socket equipped with a plug blocking device is disclosed in the invention patent with the application No. 200480006812.1.

In existing GFCI sockets, part of the sockets employ a structure in which a wiring terminal is exposed on a housing so as to facilitate connection and save the cost, but the structure brings potential safety hazards, and the problem can be solved by arranging a protective structure which can be conveniently and quickly assembled and disassembled.

### SUMMARY

In view of the defects in the background art, the present invention provides a ground fault circuit interrupter (GFCI) socket so as to solve the technical problem. A wiring terminal of the GFCI socket has a protective structure which is capable of being conveniently and quickly assembled and disassembled.

To this end, the present invention employs the following technical solutions for achievement:

A protective structure for a wiring terminal of a GFCI socket includes a housing, where an electronic assembly is arranged in the housing, the wiring terminal is arranged on an outer side of the housing, a protective cover is arranged at the wiring terminal, the protective cover is detachably connected to the housing in a buckled manner, and the protective cover covers an exposed portion of an electric conductor of the wiring terminal.

Preferably, one side of the housing is provided with a plurality of wiring terminals which are distributed in parallel, and the single protective cover integrally covers the plurality of wiring terminals on one side.

Preferably, one side of the housing is provided with two wiring terminals which are distributed in parallel, the protective cover includes a protective cover main body and covering sheets corresponding to the two wiring terminals, and a back side of an upper portion of the protective cover main body is provided with an inserting block which is distributed downwards. A side surface of the housing is provided with an inserting platform corresponding to the inserting block, the inserting platform is provided with a slot which is distributed vertically, and the inserting block is inserted into the slot from top to bottom during buckling. The housing is fixedly provided with a pair of L-shaped clamping members which are uniformly inward or outward corresponding to the covering sheets, and side portions of the covering sheets are clamped into clamping grooves formed between the L-shaped clamping members and the housing.

Preferably, in a buckled state of the protective cover, the L-shaped clamping members are positioned between the two covering sheets, and the clamping grooves formed between the L-shaped clamping members and the housing are oppositely arranged outwards.

Preferably, in a buckled state of the protective cover, the two L-shaped clamping members are arranged at a left outer side of the left covering sheet and a right outer side of the right covering sheet respectively, and the clamping grooves formed between the L-shaped clamping members and the housing are oppositely arranged inwards.

Preferably, the inserting block includes an inserting block main body and clamping strips on two sides of the inserting block main body, where the slot includes a slot main body which is opened towards the front and vertical sliding grooves which are concave towards two sides respectively on the slot main body, and after the inserting block is inserted into the slot, the clamping strips are inserted and buckled into the vertical sliding grooves from top to bottom.

Preferably, the wiring terminal is arranged in an inner groove, and a clamping block is arranged on the protective cover corresponding to the inner groove. The clamping block is provided with an inclined surface which is distributed downwards, and after the protective cover is inserted and buckled on the housing, the clamping block is clamped on a lower side of an upper wall of the inner groove.

Preferably, inner sides of the covering sheets are provided with bevel chamfers.

Preferably, two sides of an upper portion of the protective cover are provided with tripping pins which are inclined outwards and upwards respectively.

The present invention has the technical effects: the protective cover can be inserted and buckled on the housing of the socket after the wiring terminal is connected to a conductive wire, the two covering sheets achieve insulation protection by covering the wiring terminal, and the wiring terminal is prevented from being touched by mistake to influence conductive connection as well as avoiding an electric shock and a short circuit. Moreover, the protective cover of the present invention employs an insertion structure between the inserting block and the slot to achieve a fixing structure of three-point positioning in combination with clamped connection between the clamping grooves formed by the L-shaped clamping members and the side portions of the covering sheets. Furthermore, the clamped and buckled structure between the clamping block and the upper wall of the inner groove forms clamped and buckled and fixing structures which are opposite in direction and restrict each other in combination with a structure between the inserting block and the slot, such that firmness of buckling on the housing 1 of the protective cover is improved. Except for the firm insertion and buckled connection structure, assembly and disassembly are also quite convenient, buckling can be achieved only by means of downward insertion, and tripping and taking down of the protective cover can be achieved only by means of simultaneous pressing of the tripping pins on the both sides of the protective cover as well as upward pushing.

### BRIEF DESCRIPTION OF THE DRAWINGS

FIG. 1 is a schematic diagram of a three-dimensional structure of a GFCI socket of the present invention;

FIG. 2 is a schematic diagram of a three-dimensional structure from a top view of FIG. 1;

FIG. 3 is a schematic structural diagram of a GFCI socket after disassembly of a protective cover in FIG. 1;

FIG. 4 is a schematic structural diagram of a protective cover from a front view in FIG. 1;

FIG. 5 is a left side view of FIG. 4;

FIG. 6 is a top view of FIG. 4; and

FIG. 7 is a schematic diagram of a three-dimensional structure from a back view of FIG. 4.

### DETAILED DESCRIPTION OF THE EMBODIMENTS

In order to further illustrate the technical means configured to achieving the intended objectives of the present invention and the technical effects of the present invention, the particular embodiments, structures and features of the present invention, and effects thereof are described in detail hereinafter in conjunction with the accompanying drawings and preferred examples.

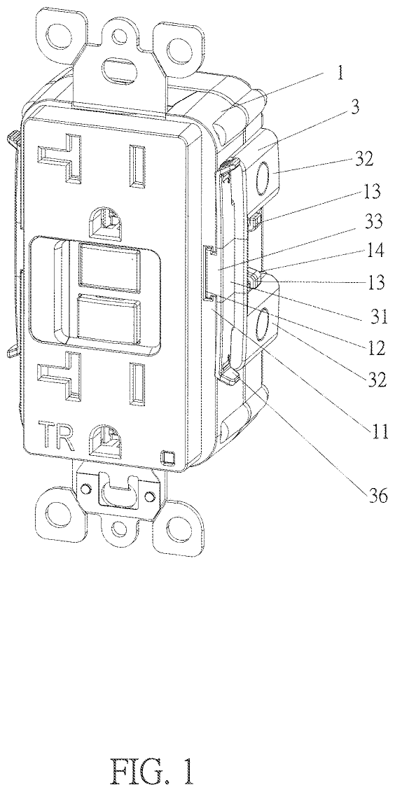

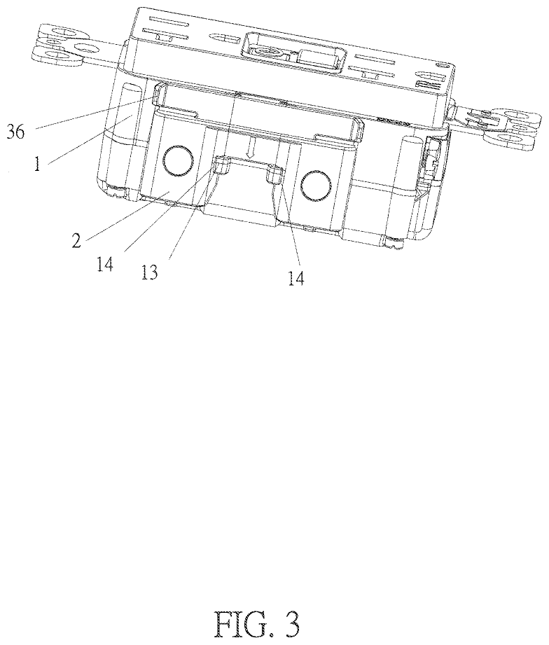

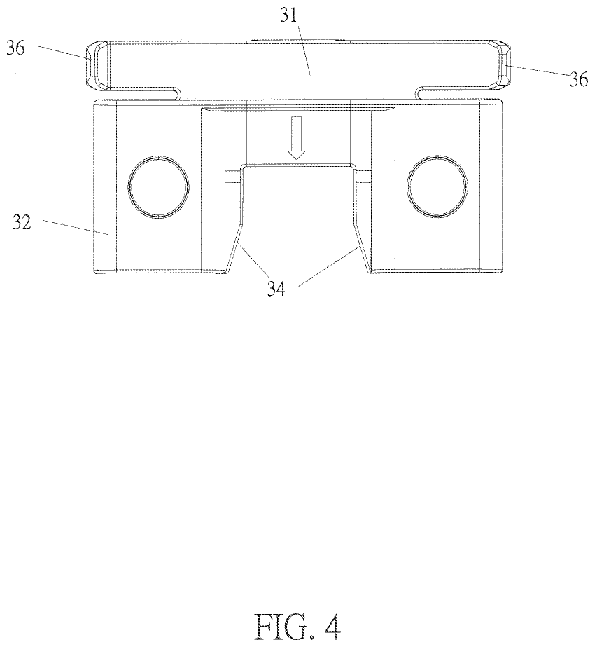

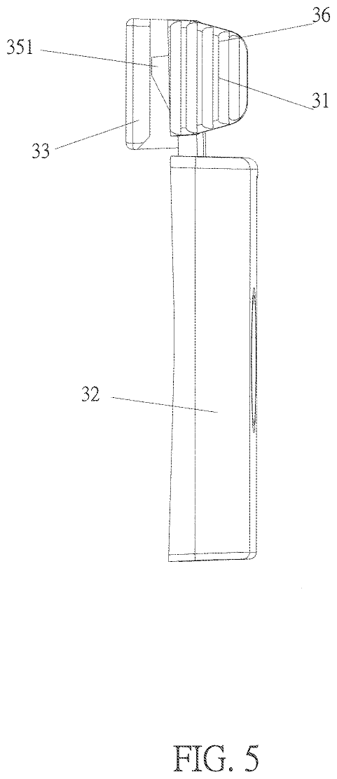

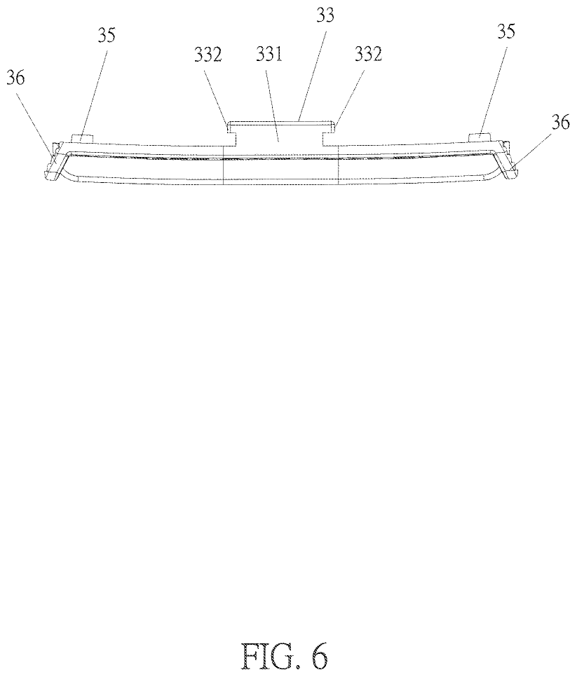

1. Referring to FIGS. 1-7, a protective structure for a wiring terminal of a ground fault circuit interrupter (GFCI) socket is provided in Example 1 of the present invention and includes a housing 1, where an electronic assembly is arranged in the housing 1, the wiring terminal 2 is arranged on an outer side of the housing 1, a protective cover 3 is arranged at the wiring terminal 2, the protective cover 3 is detachably connected to the housing 1 in a buckled manner, and the protective cover 3 covers an exposed portion of an electric conductor of the wiring terminal 2. Generally, one side of the housing 1 is provided with a plurality of wiring terminals 2 which are distributed in parallel, and the single protective cover 3 integrally covers the plurality of wiring terminals 2 on one side. In this example, one side of the housing 1 is provided with two wiring terminals 2 which are distributed in parallel, and the wiring terminals 2 are arranged on both sides of the housing 1. The protective cover 3 includes a protective cover main body 31 and covering sheets 32 corresponding to the two wiring terminals 2, a back side of an upper portion of the protective cover main body 32 is provided with an inserting block 33 which is distributed downwards, and a lower portion of the inserting block 33 is separated from the protective cover main body 31. A side surface of the housing 1 is provided with an inserting platform 11 corresponding to the inserting block 33, the inserting platform 11 is provided with a slot 12 which is distributed vertically, and the inserting block 33 is inserted into the slot 12 from top to bottom during buckling. The housing 1 is fixedly provided with a pair of L-shaped clamping members 13 which are uniformly inward or outward corresponding to the covering sheets 32, and side portions of the covering sheets 32 are clamped into clamping grooves 14 formed between the L-shaped clamping members 13 and the housing 1. In a buckled state of the protective cover 3, the L-shaped clamping members 13 are positioned between the two covering sheets 32, and the clamping grooves 14 formed between the L-shaped clamping members 13 and the housing 1 are oppositely arranged outwards. The inserting block 33 includes an inserting block main body 331 and clamping strips 332 on two sides of the inserting block main body 331. The slot 12 includes a slot main body 121 which is opened towards the front and vertical sliding grooves 122 which are concave towards two sides respectively on the slot main body 121, and after the inserting block 33 is inserted into the slot 12, the clamping strips 332 are inserted and buckled into the vertical sliding grooves 122 from top to bottom. Inner sides of the covering sheets 32 are provided with bevel chamfers 321, and by means of the bevel chamfers 321, the protective cover 3 may be clamped into the clamping grooves 14 formed by the L-shaped clamping members along with the bevel chamfers 321 when being inserted downwards and touching the L-shaped clamping members 13. Moreover, in order to facilitate tripping and disassembly of the protective cover, two sides of an upper portion of the protective cover are provided with tripping pins 36 which are inclined outwards and upwards respectively.

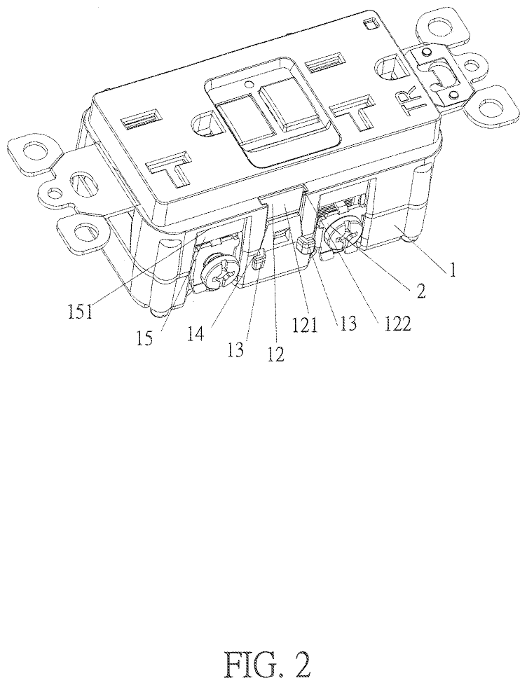

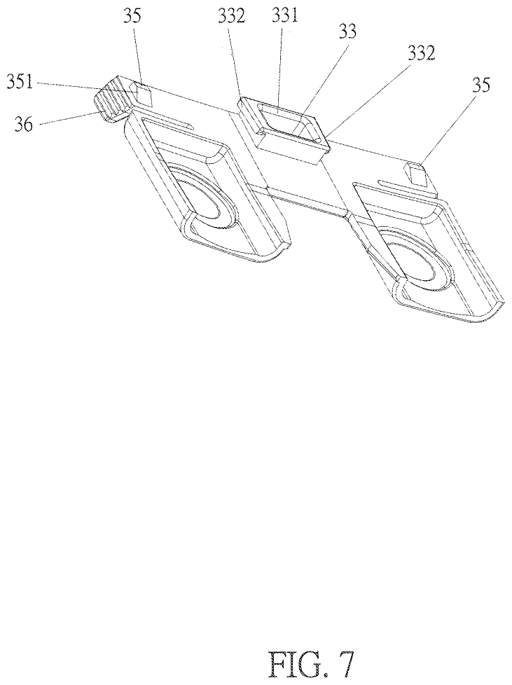

Referring to FIG. 2 and FIG. 7, in order to improve firmness of insertion and buckling, in Example 1, the wiring terminal 2 is arranged in an inner groove 15, and a clamping block 35 is arranged on the protective cover 3 corresponding to the inner groove 15. The clamping block 35 is provided with an inclined surface 351 which is distributed downwards, and by means of the inclined surface 351, the protective cover 3 may slide downwards along with the inserting platform 11 to be clamped into a lower side of an upper wall of the inner groove 15 when being inserted downwards, such that blocking is avoided. After the protective cover 3 is inserted and buckled on the housing 1, the clamping block 35 is clamped on the lower side of the upper wall 151 of the inner groove 15. The clamped and buckled structure between the clamping block and the upper wall 151 of the inner groove 15 forms clamped and buckled and fixing structures which are opposite in direction and restrict each other in combination with a structure between the inserting block 33 and the slot 12, such that firmness of buckling on the housing 1 of the protective cover 3 is improved.

Referring to FIG. 1, in Example 2 of the present invention, the L-shaped clamping members 13 may also be arranged at two side ends. For example, in a buckled state of the protective cover 3, the two L-shaped clamping members 13 are arranged at a left outer side of the left covering sheet 32 and a right outer side of the right covering sheet 32 respectively, and the clamping grooves 14 formed between the L-shaped clamping members 13 and the housing 1 are oppositely arranged inwards.

A using method of the present invention is as follows: 1. When not in use, the protective cover 3 is buckled on the housing 1 of the GFCI socket from top to bottom, the two covering sheets 32 cover the two wiring terminals 2 respectively. After the inserting block 33 on the protective cover 3 is inserted into the slot 12, the clamping strip 332 of the inserting block is inserted into the vertical sliding groove 122 from top to bottom, and an inner side of the covering sheet 32 is clamped into the clamping groove 14 formed between the L-shaped clamping member 13 and the housing 1, thereby protecting the GFCI socket during transportation and storage. 2. During use, tripping and taking down of the protective cover 3 can be achieved only by means of simultaneous pressing of the tripping pins 36 on the both sides of the protective cover as well as upward pushing of the protective cover 3, such that the protective cover is separated from the clamping groove 14 and the slot 12 on the housing 1, and then a conductive wire can be connected to the wiring terminal 2. After wiring is completed, the protective cover 3 is inserted and buckled on the housing 1 from top to bottom again, and this time, insulation protection and accidental touch disconnection protection are achieved.

The foregoing descriptions are merely preferred examples of the present invention, and are not intended to limit the present invention in any form. Although the present invention has been disclosed as above by means of the preferred examples, these examples are not for defining the present invention. Those skilled in the art can make certain alterations or modifications by using the technical contents disclosed above without departing from the scope of the technical solutions of the present invention so as to arrive at equivalent examples with equivalent changes. However, any simple amendments, equivalent changes, and modifications made to the above examples according to the technical essence of the present invention without departing from the contents of the technical solutions of the present invention still fall within the scope of the technical solutions of the present invention.

We claim:

1. A protective structure for a wiring terminal of a ground fault circuit interrupter (GFCI) socket, comprising a housing, wherein an electronic assembly is arranged in the housing, the wiring terminal is arranged on an outer side of the housing, a protective cover is arranged at the wiring terminal, the protective cover is detachably connected to the housing in a buckled manner, and the protective cover covers an exposed portion of an electric conductor of the wiring terminal.

2. The protective structure for a wiring terminal of a GFCI socket according to claim 1, wherein one side of the housing is provided with a plurality of wiring terminals which are distributed in parallel, and the single protective cover integrally covers the plurality of wiring terminals on one side.

3. The protective structure for a wiring terminal of a GFCI socket according to claim 2, wherein one side of the housing is provided with two wiring terminals which are distributed in parallel, the protective cover comprises a protective cover main body and covering sheets corresponding to the two wiring terminals, a back side of an upper portion of the protective cover main body is provided with an inserting block which is distributed downwards, a side surface of the housing is provided with an inserting platform corresponding to the inserting block, the inserting platform is provided with a slot which is distributed vertically, the inserting block is inserted into the slot from top to bottom during buckling, the housing is fixedly provided with a pair of L-shaped clamping members which are uniformly inward or outward corresponding to the covering sheets, and side portions of the covering sheets are clamped into clamping grooves formed between the L-shaped clamping members and the housing.

4. The protective structure for a wiring terminal of a GFCI socket according to claim 3, wherein in a buckled state of the protective cover, the L-shaped clamping members are positioned between the two covering sheets, and the clamping grooves formed between the L-shaped clamping members and the housing are oppositely arranged outwards.

5. The protective structure for a wiring terminal of a GFCI socket according to claim 3, wherein in a buckled state of the protective cover, the two L-shaped clamping members are arranged at a left outer side of the left covering sheet and a right outer side of the right covering sheet respectively, and the clamping grooves formed between the L-shaped clamping members and the housing are oppositely arranged inwards.

6. The protective structure for a wiring terminal of a GFCI socket according to claim 1, wherein the inserting block comprises an inserting block main body and clamping strips on two sides of the inserting block main body, the slot comprises a slot main body which is opened towards the front and vertical sliding grooves which are concave towards two sides respectively on the slot main body, and after the inserting block is inserted into the slot, the clamping strips are inserted and buckled into the vertical sliding grooves from top to bottom.

7. The protective structure for a wiring terminal of a GFCI socket according to claim 4, wherein inner sides of the covering sheets are provided with bevel chamfers.

8. The protective structure for a wiring terminal of a GFCI socket according to claim 1, wherein the wiring terminal is arranged in an inner groove, a clamping block is arranged on the protective cover corresponding to the inner groove, the clamping block is provided with an inclined surface which is distributed downwards, and after the protective cover is inserted and buckled on the housing, the clamping block is clamped on a lower side of an upper wall of the inner groove.

9. The protective structure for a wiring terminal of a GFCI socket according to claim 6, wherein the wiring terminal is arranged in an inner groove, a clamping block is arranged on the protective cover corresponding to the inner groove, the clamping block is provided with an inclined surface which is distributed downwards, and after the protective cover is inserted and buckled on the housing, the clamping block is clamped on a lower side of an upper wall of the inner groove.

10. The protective structure for a wiring terminal of a GFCI socket according to claim 9, wherein two sides of an upper portion of the protective cover are provided with tripping pins which are inclined outwards and upwards respectively.
